(19) United States
(12) Patent Application Publication
(10) Pub. No.: US 2023/0021822 A1
(43) Pub. Date: Jan. 26, 2023

(54) DEVICE AND METHOD FOR PRODUCT RECALL MANAGEMENT

(71) Applicant: Honda Motor Co., Ltd., Tokyo (JP)

(72) Inventors: Tiffany Tam, Palos Verdes Estates, CA (US); Shinngaram Choi, Torrance, CA (US); Dillon Kane, Torrance, CA (US)

(21) Appl. No.: 17/383,306

(22) Filed: Jul. 22, 2021

(51) Int. Cl. G06Q 30/00; H04L 29/08; H04W 4/029

(52) U.S. Cl. CPC G06Q 30/014; H04L 67/26; H04W 4/029

(57) ABSTRACT

A first computing device for product recall management is provided. The first computing device may include a display screen which displays a user interface (UI), and circuitry communicably coupled to a server, and the display screen. The UI may display UI elements for a plurality of products purchased by a first user. The circuitry may transmit product information associated with a product to the server. The circuitry may receive, from the server, recall information associated with the product, indicative of a recall initiated by a manufacturer or a dealer for the product. The circuitry may control the display screen to change a display characteristic of a UI element of the product, and one or more requests associated with the product based on the recall information. The one or more requests may include at least one of: a rent request, an exchange request, or a sale request for the product.

### BACKGROUND

Recent advancements in the field of product management have led to development of various advanced technologies and systems to enhance management of products which are sold by a manufacturer or a dealer, and purchased by an end-user (such as, an owner of the product). Typically, a computing device may be used for management of the product, and which may include an application software to improve the management associated with the product. Such application software may be utilized for various purposes, for example to store information about the purchased product on the computing device, receive offers, or manage various operations (like renting, selling, etc.) related with the purchased product. In certain situations, the products are recalled by the manufacturer or dealer due to any identified faults or problems with the product or with an in-built component (either software, hardware, or mechanical), to further avoid any issues related to security or privacy related with the end-users. However, during the recall of the products, certain conventional solutions or application software may not provide appropriate solutions or management to the end-users, which may further increase a risk (i.e. associated with the security or privacy) for the end-users with the usage of the recalled products. Therefore, an enhanced system may be required to mitigate such risk during the recall of the products and to provide high-quality management of the products to the end-users.

Further limitations and disadvantages of conventional and traditional approaches will become apparent to one of ordinary skill in the art, through comparison of the described systems with some aspects of the present disclosure, as set forth in the remainder of the present application and with reference to the drawings.

### SUMMARY

According to an embodiment of the present disclosure, a first computing device for product recall management is provided. The first computing device may include a display screen that may be configured to displays a user interface (UI). The UI may display a plurality of UI elements for a plurality of products purchased by a first user of the first computing device. The first computing device may further include circuitry communicatively coupled to a server and the display screen. The circuitry may be configured to transmit product information associated with at least one product of the plurality of products to the server. The circuitry may be further configured to receive, from the server, recall information associated with the at least one product of the plurality of products. The recall information may indicate a recall initiated by a manufacturer or a dealer for the at least one product of the plurality of products. The circuitry may be further configured to control the display screen to change a display characteristic of a UI element associated with the at least one product of the plurality of products based on the received recall information. The circuitry may be further configured to control one or more requests associated with the at least one product of the plurality of products based on the received recall information. The one or more requests may include at least one of: a rent request, an exchange request, or a sale request for the at least one product of the plurality of products.

According to another embodiment of the disclosure, a method for product recall management is provided. The method may be performed in a first computing device. The first computing device may include a display screen which displays a user interface (UI). The UI may be configured to display a plurality of UI elements for a plurality of products purchased by a first user of the first computing device. The method may include a transmission of product information associated with at least one product of the plurality of products to a server. The method may further include a reception, from the server, of recall information associated with the at least one product of the plurality of products. The recall information may indicate a recall initiated by a manufacturer or a dealer for the at least one product of the plurality of products. The method may further include a control of the display screen to change a display characteristic of a UI element of the at least one product of the plurality of products based on the received recall information. The method may further include control of one or more requests associated with the at least one product of the plurality of products based on the received recall information. The one or more requests may include at least one of: a rent request, an exchange request, or a sale request for the at least one product of the plurality of products.

According to another embodiment of the disclosure, there is provided a non-transitory computer-readable medium having stored thereon, computer-executable instructions that when executed by a first computing device, causes the first computing device to execute operations. The first computing device may include a display screen which displays a user interface (UI). The UI may be configured to display a plurality of UI elements for a plurality of products purchased by a first user of the first computing device. The operations may include a transmission of product information associated with at least one product of the plurality of products to a server. The operations may further include a reception, from the server, of recall information associated with the at least one product of the plurality of products. The recall information may indicate a recall initiated by a manufacturer or a dealer for the at least one product of the plurality of products. The operations may further include a control of the display screen to change a display characteristic of a UI element of the at least one product of the plurality of products based on the received recall information. The operations may further include control one or more requests associated with the at least one product of the plurality of products based on the received recall information. The one or more requests may include at least one of: a rent request, an exchange request, or a sale request for the at least one product of the plurality of products.

### BRIEF DESCRIPTION OF THE DRAWINGS

FIG. 1 is a block diagram that illustrates an exemplary environment for product recall management on a first computing device, in accordance with an embodiment of the disclosure.

FIG. 2 is a block diagram that illustrates an exemplary first computing device for product recall management, in accordance with an embodiment of the disclosure.

FIGS. 3A and 3B collectively illustrate an exemplary processing pipeline for product recall management on a first computing device, in accordance with an embodiment of the disclosure.

FIGS. 4A and 4B collectively illustrate an exemplary scenario for product recall management on a first computing device, in accordance with an embodiment of the disclosure.

FIG. 5 is a diagram that illustrates an exemplary processing pipeline to decline one or more requests based on recall information, in accordance with an embodiment of the disclosure.

FIG. 6 is a diagram that illustrates an exemplary processing pipeline for a refund operation based on recall information, in accordance with an embodiment of the disclosure.

FIG. 7 is a flowchart that illustrates an exemplary method for product recall management on a first computing device, in accordance with an embodiment of the disclosure.

### DETAILED DESCRIPTION

Various embodiments of the present disclosure may be found in a first computing device for automated product recall management. The first computing device (such as a smartphone, or a tablet) may automatically control one or more requests (such as a rent request, an exchange request, or a sale request) associated with a plurality of products purchased by a first user of the first computing device. The first computing device may control one or more requests based on a determination of recall initiated for at least one product of the plurality of products. The first computing device may include a display screen that may display a user interface (UI). The UI (such as the user interface (UI) of software application) may display a plurality of UI elements (such as, but not limited to, icons, buttons, a list, thumbnails, or images) associated with the plurality of products (such as, but not limited to, an automobile, a power equipment, an entertainment equipment, a marine equipment, or a decorative item) that may be purchased by the first user and registered on the first computing device. The first computing device may be configured to transmit product information associated with at least one product of the plurality of products to a server (such as a server associated with a manufacturer or a dealer of the product). The server may be communicatively coupled with the first computing device. For example, the product information associated with the product of the plurality of products may include, but is not limited to, a product identification number, a product serial number, a batch number, a product name, product license information, etc. The first computing device may further receive, from the server, recall information associated with the product of the plurality of products. The recall information may indicate a recall initiated by a manufacturer or a dealer for the product of the plurality of products. For example, the recall initiated by the manufacturer or the dealer for the product may be due to, but is not limited to, a damage associated with the product or with related components, a defect/fault associated with the product or with related components, a software bug in the product, a quality issue associated with the product or with related components, or a security or privacy issue associated with the product or with related components. Based on the received recall information, the first computing device may automatically control the display screen to change a display characteristic of a UI element associated with the product for which the recall has been initiated. For example, the display characteristic of the UI element of the product of the plurality of products may include, but is not limited to, a highlighting, a font size, a font style, a foreground color, un-editable user interface (UI) element, etc. The first computing device may further control one or more requests associated with the product of the plurality of products based on the received recall information. The one or more requests may include, but is not limited to, at least one of a rent request, an exchange request, or a sale request for the product of the plurality of products. For example, the control of the one or more requests may include restriction of the one or more requests associated with the product of the plurality of products for which the recall is being initiated.

Conventionally, when a recall is initiated by the manufacturer or the dealer, the first user may receive the recall information associated with the purchased product via at least one of: a traditional postal mail, a customer-care executive over a call, or a website that may be regulated by personnel assigned by the manufacturer or dealer. However, such reception of the recall information may require substantial amount of time (such as, a few days, weeks, or a month), which may result to a time lag between the recall initiation and the recall reception. Therefore, due to the time lag, the security or privacy of the first user using the recalled product (or a person who has rented/exchanged/purchased the recalled product) may be compromised or at risk, which may result in causing harm or losses to the different people currently associated with the recalled product.

The disclosed first computing device may automatically receive the recall information associated with any product registered on the first computing device, when the recall may be initiated either by the manufacturer, by the dealer, or by a competent authority assigned by the manufacturer or dealer having the rights to perform the recall on a particular product from the registered plurality of products. Thereafter, upon issuance of the recall on any product registered on the first computing device, any further action (like renting, exchange, or selling) with respect to the recalled product may be suspended or restricted until being further released by the manufacturer or the dealer of the product. Thus, the disclosed first computing device may automatically control (i.e. restrict) one or more requests (like the rent request, the exchange request, or the sale request) received from different devices (or associated people) for the recalled product. Further, the disclosed first computing device may automatically control the display characteristics (like highlighting) of the UI element associated with registered product which is being recalled. The automatic change in the display characteristics for the recalled product may notify the first user about the recalled products (and about their restrictions) in timely manner. Therefore, the disclosed first computing device may automatically freeze the operations related to the recalled product and further ensures appropriate security and/or privacy for the first user, or any other users who may have rented or requested to rent (or exchange or purchase) the product recalled from the manufacturer or dealer.

In an embodiment, the first computing device may further receive, from the server, contact information (such as, a contact number, an address, or schedule information) associated with the manufacturer or the dealer of the product in order to fulfil one or more operations associated with the product for which the recall is initiated. The one or more operations may include at least one of, but is not limited to a return operation, a replace operation, a refund operation, or repair operation associated with the product of the plurality of products registered on the first computing device. The received contact information (or other information related to such operations) may effectively assist the first user of the first computing device to perform appropriate operations (like return, repair, refund, or replace) with the recall product in real-time. Thus, the disclosed first computing device may effectively manage a product recall initiated by the manufacturer or the dealer.

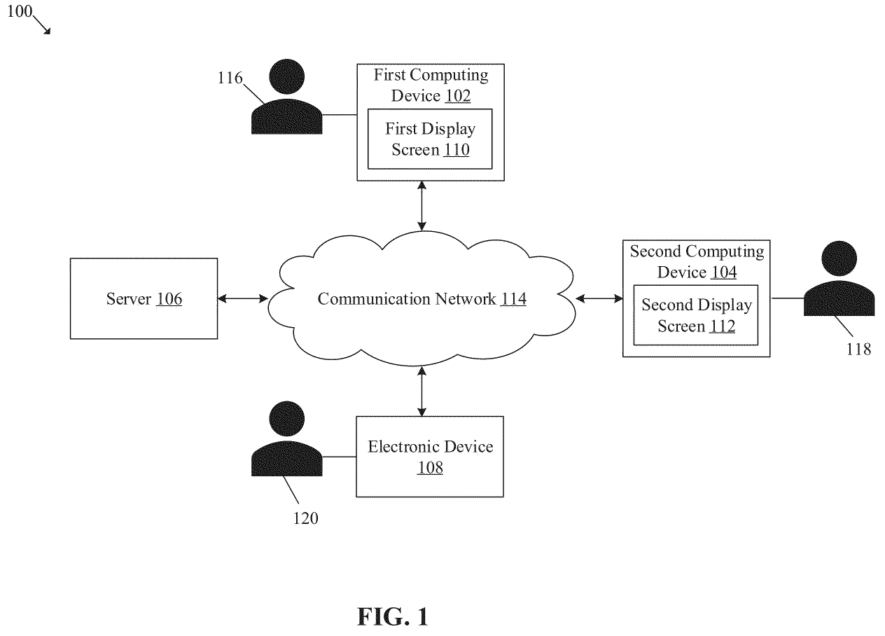

FIG. 1 is a block diagram that illustrates an exemplary environment for product recall management on a first computing device, in accordance with an embodiment of the disclosure. With reference to FIG. 1, there is shown an environment 100. The environment 100 may include a first computing device 102, a second computing device 104, a server 106, and an electronic device 108. The first computing device 102, and the second computing device 104 may further include a first display screen 110 and a second display screen 112, respectively. The first computing device 102, the second computing device 104, the server 106, and the electronic device 108 may be communicatively coupled with each other, via a communication network 114.

In the environment 100, there is further shown a first user 116 associated with the first computing device 102, a second user 118 associated with the second computing device 104, and a manufacturer or a dealer 120, associated with the electronic device 108. The first user 116 and the second user 118 may be an owner or user of the first computing device 102 and the second computing device 104, respectively. It may be noted that, the first computing device 102 and the second computing device 104 shown in FIG. 1 is presented merely as an example. The environment 100 of FIG. 1 may include more or less than two computing devices, without departing from the scope of the present disclosure.

The first computing device 102 may include suitable logic, circuitry, interfaces, and/or code that may be configured to enable a user (e.g., the first user 116) of the first computing device 102 to effectively manage a product for which a recall may be initiated by the manufacturer or the dealer 120 associated with at least one product of a plurality of products purchased by the first user 116 and/or registered on the first computing device 102. In an embodiment, the first computing device 102 may include a web based client to access a client-side application or may include a software application installed on the first computing device 102 for product recall management. The software application may include a user interface (UI) to execute several requests, such as, but not limited to, to a rental request, an exchange request, or a sale request for the plurality of products. The user interface (UI) may display a plurality of UI elements for the plurality of products purchased by the first user 116 of the first computing device 102. The first computing device 102 may further control the first display screen 110 to change a display characteristic of a UI element of the product or may indicate a change in the status associated with the product based on received recall information for the product. Examples of the first computing device 102 may include, but are not limited to, a mobile phone, a smartphone, a cellular phone, a tablet computing device, a computer work-station, a personal computer, a gaming device, a server, a mainframe machine, a consumer electronic (CE) device, or any computing device with an inbuilt or installed web-client or the software application associated with the product recall management.

The first display screen 110 may include suitable logic, circuitry, and interfaces that may be configured to display an output of the first computing device 102. The first display screen 110 may be utilized to displays the user Interface (UI) for the plurality of products registered on the first computing device 102 or registered with the software application installed on the first computing device 102. In some embodiments, the first display screen 110 may be an externally coupled display device associated with the first computing device 102. The first display screen 110 may be a touch screen which may enable the first user 116 to provide a user input via the first display screen 110. The touch screen may be at least one of a resistive touch screen, a capacitive touch screen, a thermal touch screen or any other touch screen using which inputs can be provided to the first display screen 110. The first display screen 110 may be realized through several known technologies such as, but not limited to, at least one of a Liquid Crystal Display (LCD) display, a Light Emitting Diode (LED) display, a plasma display, or an Organic LED (OLED) display, or other display technologies. The functions of the second computing device 104 and the second display screen 112 may be similar to the functions of the first computing device 102 and the first display screen 110, respectively. Therefore, the description of the second computing device 104 and the second display screen 112 is omitted from the disclosure for the sake of brevity. In addition, the second computing device 104 may transmit a request (like a rent request, an exchange request, a sale request) to the first computing device 102 for one or more products registered on the first computing device 102. The second computing device 104 may further receive a notification including the recall information about one or more products indicated in the transmitted request.

The server 106 may include suitable logic, circuitry, and interfaces, and/or code that may be configured to receive the recall information from the electronic device 108 associated with the manufacturer or the dealer 120. The server 106 may include a database (not shown) to store the received recall information associated with at least one product of the plurality of products. The server 106 may receive product information about a product from the first computing device 102, and further provide the stored recall information to the first computing device 102 based on the received product information. Since databases use to store and retrieve data and their other basic operations are well known to one of ordinary skill in the art, description of the database is omitted from the disclosure for the sake of brevity. In an embodiment, the server 106 may provide notifications to the first computing device 102 about the recalled products registered on the first computing device 102. In an exemplary embodiment, the server 106 may be implemented as a cloud server and may execute operations through web applications, cloud applications, HTTP requests, repository operations, file transfer, and the like. Other example implementations of the server 106 may include, but are not limited to, a database server, a file server, a web server, an application server, a mainframe server, or a cloud computing server.

In at least one embodiment, the server 106 may be implemented as a plurality of distributed cloud-based resources by use of several technologies that are well known to those ordinarily skilled in the art. A person with ordinary skill in the art will understand that the scope of the disclosure may not be limited to the implementation of the server 106 and the first computing device 102 as two separate entities. In certain embodiments, the functionalities of the server 106 can be incorporated in its entirety or at least partially in the first computing device 102, without a departure from the scope of the disclosure.

The electronic device 108 may include suitable logic, circuitry, interfaces, and/or code that may be associated with the manufacturer or the dealer 120 and may be configured to transmit the recall information associated with the at least one product of the plurality of products to the server 106. The electronic device 108 may be configured to update the server 106 periodically with the recall information associated with the plurality of products. In an embodiment, the electronic device 108 may be configured to transmit notification information related to the recall information associated with at least one product of the plurality of products, to the server 106. In further embodiment, the electronic device 108 may transmit contact information of the manufacturer or the dealer 120 to the first computing device 102 for one or more operations (like replace, refund, repair operations) for the recalled products. Examples of the electronic device 108 associated with the manufacturer or the dealer 120 of the plurality of products may include, but are not limited to, a hand-held device, a computing device, a smartphone, a cellular phone, a mobile phone, a gaming device, a mainframe machine, a server, a computer work-station, and/or a consumer electronic (CE) device.

The communication network 114 may include a communication medium through which the first computing device 102, the second computing device 104, the server 106, and the electronic device 108 may communicate with one another. In an embodiment, the electronic device 108 may not directly communicate with the first computing device 102 and/or the second computing device 104 depending on the architecture of implementation, but may communicate via other devices through the communication network 114. Examples of the communication network 114 may include, but are not limited to, the Internet, a cloud network, a Long-Term Evolution (LTE) network, a Wireless Local Area Network (WLAN), a Local Area Network (LAN), a telephone line (POTS), and/or a Metropolitan Area Network (MAN). Various devices in the network environment 100 may be configured to connect to the communication network 114, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, light fidelity (Li-Fi), 802.16, IEEE 802.11s, IEEE 802.11g, multi-hop communication, wireless access point (AP), device to device communication, cellular communication protocols, or Bluetooth (BT) communication protocols, or a combination thereof.

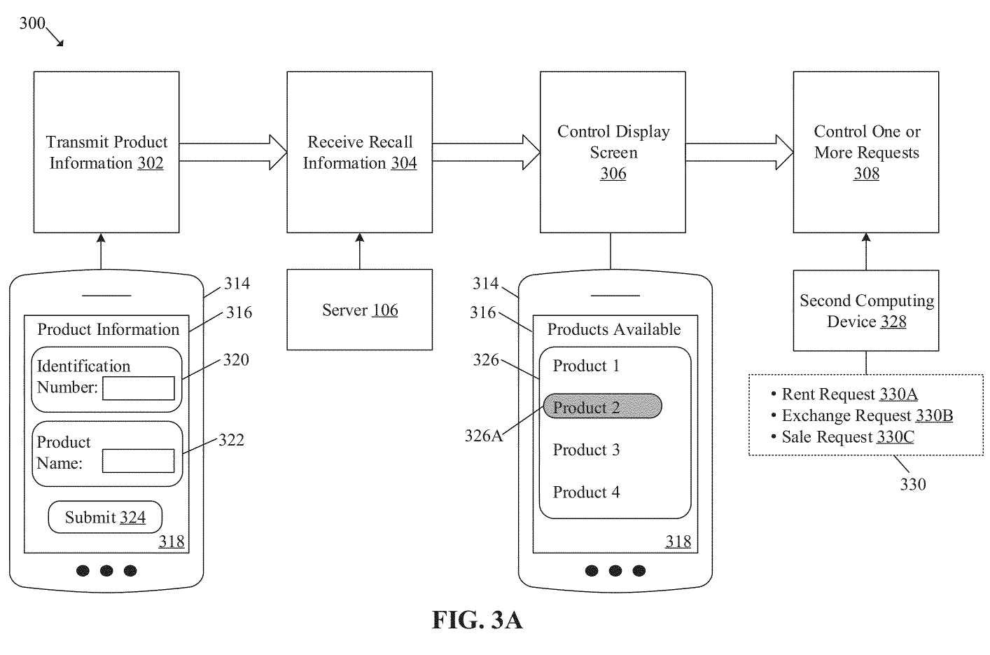

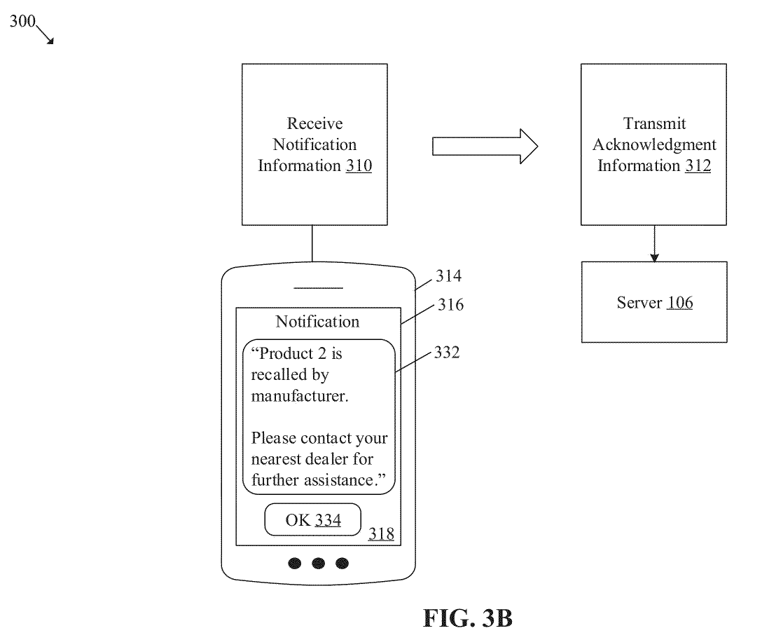

In operation, the first computing device 102 may be configured to receive, via a user interface (UI) on the first display screen 110, a first user input indicative of the product information associated with at least one product of the plurality of products registered on the first computing device 102. The first user input may be received from the first user 116 who may have purchased the plurality of products. The first computing device 102 may transmit the product information associated with at least one product to the server 106. Examples of the product information may include, but are not limited to, a product identification number, a product serial number, a batch number, a product name, or product license information. The receipt of the first user input for the product information is further described, for example, in FIG. 3A. In another embodiment, the first computing device 102 may automatically retrieve the product information (i.e. stored in an in-built memory) associated with at least one product of the plurality of products and transmit the retrieved product information associated with at least one product to the server 106 for the determination of the recall initiated by the manufacturer or the dealer 120 for the product.

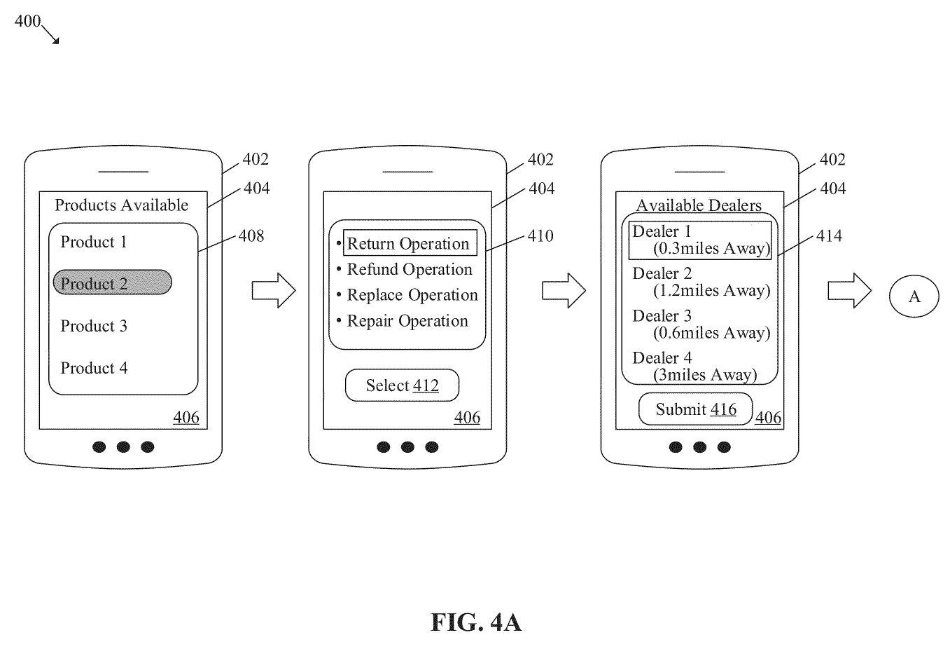

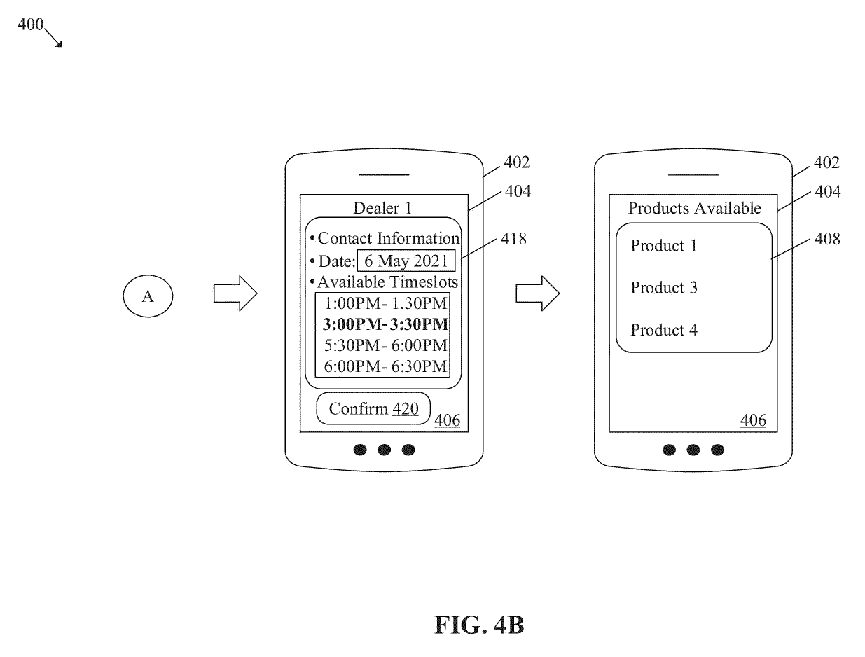

The first computing device 102 may receive from the server 106, recall information associated with at least one product of the plurality of products for which the product information is transmitted. The recall information may indicate a recall initiated by the manufacturer or the dealer 120 for at least one product of the plurality of products. The reception of the recall information associated with at least one product of the plurality of products is described, for example, in FIG. 3A. In an embodiment, the first computing device 102 may receive the recall information about one or more registered products from the server 106, without the transmission of the product information to the server 106. The server 106 may transmit the recall information, when the recall information about a particular product is received from the corresponding electronic device 108 of the manufacturer or the dealer 120 of the particular product. The first computing device 102 may further control the display screen (such as the first display screen 110) to change a display characteristic of a user interface (UI) element of at least one product of the plurality of products based on the received recall information. For example, the display characteristic of the user interface (UI) element may include, but are not limited to, a highlighting, a font size, a font style, or a foreground color. Based on the changed display characteristic, the first computing device 102 may further freeze or disable the user interface (UI) to further avoid transactions or operations (like rent, selling, or exchange) to be performed on the recalled product. The first computing device 102 may further control one or more requests, such as a transactional request, associated with at least one product of the plurality of products based on the received recall information. The one or more requests may include, but are not limited to, a rent request, an exchange request, or a sale request for at least one product of the plurality of products registered on the first computing device 102. For example, the control of the one or more requests may include restriction of the one or more requests associated with at least one product of the plurality of products. The control of the first display screen 110 to change the display characteristics, and the one or more operations is described, for example in FIGS. 3A, 3B, 4A, and 4B.

The disclosed first computing device 102 may directly receive (in real-time) notifications about the recall information (i.e. associated with at least one product of the plurality of products) from the server 106, when the recall is initiated by the manufacturer or the dealer 120. Thereafter, the first computing device 102 may automatically process the recall initiated by the manufacturer or dealer 120 based on a change of a product status (i.e. display characteristics) in the UI element of the recalled product, to further restrict (or freeze) the one or more requests (i.e. rent, exchange, or sale) associated with the product. The control of such requests and timely notifications (i.e. changed display characteristics) about the recalled product may ensure (or mitigate/reduce risks related to) security or privacy for the first user 116 (such as the owner of the product) or for other users (such as the second user 118 who may rent, purchase, or exchange the recalled product). Thus, the disclosed first computing device 102 may effectively manage and/or process the products for which the recall is initiated by the manufacturer or the dealer 120 of the product.

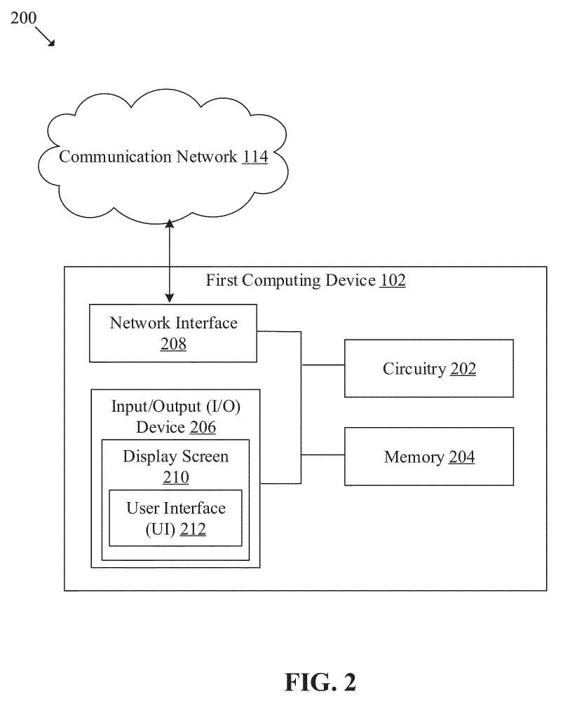

FIG. 2 is a block diagram that illustrates an exemplary first computing device for product recall management, in accordance with an embodiment of the disclosure. FIG. 2 is explained in conjunction with elements from FIG. 1. With reference to FIG. 2, there is shown a block diagram 200 of the first computing device 102. The first computing device 102 may include circuitry 202, memory 204, an input/output (I/O) device 206, and a network interface 208. The I/O device 206 may further include a display screen 210 as an exemplary implementation of the first display screen 110. The description of the display screen 210 is omitted from the present disclosure for the sake of brevity as these are well known to one of ordinary skill in the art. The display screen 210 may further display a user interface (UI) 212. The network interface 208 may connect the first computing device 102 with the server 106, and the electronic device 108, via the communication network 114.

The circuitry 202 may include suitable logic, circuitry, and/or interfaces that may be configured to execute program instructions associated with different operations to be executed by the first computing device 102. For example, some operations may include transmission of the product information to the server 106, reception of the recall information from the server 106, control of the display screen 210, and control of the one or more requests. The circuitry 202 may include one or more specialized processing units, which may be implemented as a separate processor. In an embodiment, the one or more specialized processing units may be implemented as an integrated processor or a cluster of processors that may be configured to perform the functions of the one or more specialized processing units, collectively. The circuitry 202 may be implemented based on a number of processor technologies that are known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The memory 204 may be configured to store one or more of, but not limited to, the product information associated with the plurality of products, the recall information associated with at least one product of the plurality of products, a list of manufactures or dealers associated with the plurality of products registered on the first computing device 102, and contact information associated with the manufacturer or the dealer 120 of at least one product of the plurality of products. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. The I/O device 206 may include various input and output devices, which may be configured to communicate with the circuitry 202. For example, the first computing device 102 may receive (via the I/O device 206) the user input indicative of the product information associated with at least one product of the plurality of products. The first computing device 102 may control the I/O device 206 to output the user interface 212 including information about the plurality of products registered on the first computing device 102. Examples of the I/O device 206 may include, but are not limited to, a touch screen, a keyboard, a mouse, a joystick, a display device (for example, the display screen 210), a microphone, or a speaker.

The user interface (UI) 212 may be rendered on the display screen 210. The UI 212 may be configured to display a plurality of UI elements for the plurality of products purchased by the first user 116 of the first computing device 102. Additionally, the user interface (UI) 212 may be further configured to display UI elements that may correspond to user-selectable options for, but not limited to, a view selection, a display control, and other interactive user-options. In another embodiment, the first computing device 102 may control the user interface (UI) 212 to display the recall information for the products, the contact information for the manufacturer or the dealer 120, or information about the second computing device 104 or the second user 118 who may have rented (or exchanged or purchased) the recalled products.

The network interface 208 may include suitable logic, circuitry, interfaces, and/or code that may be configured to facilitate communication between the first computing device 102, the second computing device 104, the server 106, and the electronic device 108, via the communication network 114. The network interface 208 may be implemented by use of various known technologies to support wired or wireless communication of the first computing device 102 with the communication network 114. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via a wired communication or a wireless communication or a combination thereof with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The operations of the circuitry 202 are further described, for example, in FIGS. 3A, 3B, 4A, 4B, 5, and 6. It may be noted that the first computing device 102 shown in FIG. 2 may include various other components or systems. The description of the other components or systems of the first computing device 102 has been omitted from the disclosure for the sake of brevity.

FIGS. 3A and 3B collectively illustrate an exemplary processing pipeline for product recall management on a first computing device, in accordance with an embodiment of the disclosure. FIGS. 3A and 3B are explained in conjunction with elements from FIGS. 1 and 2. With reference to FIG. 3A, there is shown an exemplary processing pipeline 300. There is further shown a first computing device 314 as an exemplary implementation of the first computing device 102 of FIG. 1. The first computing device 314 may include a display screen 316 as an exemplary implementation of the first display screen 110 of FIG. 1. The display screen 316 may be configured to display a user interface (UI) 318 as an exemplary implementation of the user interface (UI 212) of FIG. 2. The descriptions of the first computing device 314, the display screen 316, and the user interface (UI) 318 have been discussed previously in FIGS. 1 and 2 and hence omitted from the present disclosure for the sake of brevity. The user interface (UI) 318 may display a plurality of UI elements (such as a first UI element 320, a second UI element 322, and a third UI element 324). The operations 302 to 308 may be implemented by the first computing device 314 or by the circuitry 202 of FIG. 2. The operations of the exemplary processing pipeline 300 may start at 302.

At 302, product information may be transmitted. In an embodiment, the circuitry 202 may transmit the product information associated with at least one product of the plurality of products to the server 106. The plurality of products may be purchased by the first user 116 of the first computing device 314 and may be registered on the first computing device 314 or on a software application installed on the first computing device 314. Examples of the plurality of products may include, but are not limited to, a power equipment, an automobile, decorative item, an educational item, an entertainment product, a health-related product, a furniture item, a clothing product, a jewelry item, a sports-related product, or a marine equipment purchased by the first user 116 of the first computing device 314. The product information associated with at least one product of the plurality of products may include, but is not limited to, a product identification number, a product serial number, a batch number, a product name, or product license information. The product identification number may be related to a unique identification number associated with each product of the plurality of products. For example, the product identification number may indicate a unique identification number such as “1234”, and may also include other forms of numbering and formats such as alpha numeric numbering schemes. For example, for a product like an automobile, the product identification number may be a registration number or a vehicle identification number (VIN). The product serial number may be related to a unique identification number associated with the product. For example, the product serial number may indicate a chassis number, an engine number, or a unique number embossed on the product. The batch number may be related to a unique identification code associated with the product in order to identify at least one of a production time, a production date, a production venue, or an identification number. For example, a set of products of the plurality of products may have a same batch number in case the set of products are manufactured at the same venue and on the same date. The product name may be related to a name of the product. For example, the product name may indicate a model name, a model number, or a brand name of the product. The product license information may be related to an authorization document or an authorization code associated with the product. For example, the product license information may indicate a certificate or code of registration of the first user 116 for the product.

In an embodiment, the server 106 may store the transmitted product information associated with at least one product of the plurality of products. In an embodiment, the first computing device 314 may automatically determine the product information associated with the product to transmit the product information to the server 106. The first computing device 314 may retrieve the product information directly from a memory (such as the memory 204) associated with the first computing device 314. In an embodiment, the circuitry 202 may receive, via the user interface (UI) 318, a first user input indicative of the product for which the product information is retrieved from the memory 204. In another embodiment, the circuitry 202 may receive, via the user interface (UI) 318, the first user input indicative of the product information associated with the product of the plurality of products. Based on the received first user input, the circuitry 202 may transmit the product information associated with the product to the server 106. The product information may be transmitted to the server 106 to check whether the server 106 stores recall information for the product mentioned in the product information. The recall information may indicate that the product is being recalled by the manufacturer or the dealer 120 of the product.

As an example, in FIG. 3A, there is shown the first UI element 320, the second UI element 322, and the third UI element 324 through which the first user input may be accepted from the first user 116. The first UI element 320, and the second UI element 322 may correspond to, for example, a text box. For example, the first UI element 320 may be configured to receive the first user input indicative of the product identification number, and the second UI element 322 may be configured to receive another user input indicative of the product name. The third UI element 324 may be, for example, a button (such as a “Submit” button) that may be configured to receive a user confirmation to transmit the product information associated with the product to the server 106 based on the received first user input, via the user interface (UI) 318 of the first computing device 314. It may be noted that the first user input as the product identification number and the product name shown in FIG. 3A, is presented merely an example. The first user input may include only one input (like one of the product identification number, the product serial number, the batch number, the product name, or the product license information) as the product information, without any deviation from the scope of the disclosure. In another embodiment, the first user input may be a selection of an icon or an image (not shown) displayed of the user interface (UI) 318 for the product. The user interface (UI) 318 may display a plurality of icons/images for the plurality of products and the first user 116 may select an appropriate icon/image to select a product for which the product information may be retrieved from the memory 204.

At 304, the recall information may be received. In an embodiment, the circuitry 202 may receive the recall information from the server 106. The circuitry 202 may be configured to receive the recall information from the server 106, where the received recall information may be associated with the product for which the product information may be transmitted. The recall information may indicate a recall initiated by a manufacturer or a dealer (such as the manufacturer or the dealer 120) for the product related to the product information. The recall may be initiated by the manufacturer or the dealer 120 for various reasons, which may alert the first user 116 that the recalled product may not be secure or fit to use or may be a hazard to use. For example, the recall initiated by the manufacturer or the dealer 120 for the product may be due to, but is not limited to, a damage associated with the product (or with related components), a defect/fault associated with the product (or with related components), a software bug in the product, or a quality issue associated with the product, or a security or privacy issue associated with the product (or with related component).

In an embodiment, the server 106 may store the recall information for the plurality of products which may be purchased by different users and/or registered on different computing devices (such as the first computing device 314). The server 106 may receive the recall information from an electronic device (such as the electronic device 108) associated with the manufacturer or the dealer 120 of different products. The electronic device 108 may include an I/O interface to receive input from the manufacturer or the dealer 120 about the recall of a particular product. The input from the manufacturer or the dealer 120 may indicate that the particular product may be recalled due to any particular problem or issue. In an embodiment, the electronic device 108 may be further configured to transmit the recall information associated with at least one product to the server 106 which may further store the recall information for the associated product. In an embodiment, the server 106 may receive, via the I/O interface, a user input indicative of the recall information associated with at least one product, rather than receiving from the corresponding manufacturer or the dealer 120. Based on the received user input (for example received from an executive or administrator of the server 106), the server 106 may further transmit the recall information associated with the product to the first computing device 314. In other words, the server 106 may notify about the recall information of the product to the first computing device 314 when the notification is initiated based on the received user input. In another embodiment, the server 106 may transmit the recall information based on the product information received from the first computing device 314. The server 106 may search an in-build repository or database to retrieve the recall information for the received product information. In another embodiment, the server 106 may automatically transmit the recall information for different products (i.e. registered on the first computing device 314) to the first computing device 314 at regular intervals (such as in certain hours or days), without the receipt of the user input or without the receipt of the product information from the first computing device 314. Therefore, the first computing device 314 may periodically receive the recall information for different registered and/or purchased products from the server 106, without transmission of the product information for a particular product to the server 106.

In an embodiment, the circuitry 202 of the first computing device 314 may further compare the transmitted product information (i.e. associated with the product) with the received recall information associated with the same product of the plurality of products registered on the first computing device 314. The circuitry 202 may further determine that the product is being recalled by the manufacturer or the dealer 120 based on the received recall information and/or based on the comparison.

At 306, the display screen 316 may be controlled. In an embodiment, the circuitry 202 may control the display screen 316 to change a display characteristic of a user interface (UI) element 326A of the product, based on the received recall information for the same product. The user interface (UI) element 326A may be one of a plurality of UI elements 326. For example, as shown in FIG. 3A, different icons related to ‘Product 1’, ‘Product 2’, ‘Product 3’, and ‘Product 4’ may correspond to the plurality of UI elements 326 displayed on the display screen 316. The display characteristic of the user interface (UI) element 326A of the product from the plurality of products may include, but is not limited to, a highlighting, a font size, a font style, a foreground color or a highlighted un-editable user interface (UI) element (like un-editable button or text box). As an example, there is shown the plurality of UI elements 326 through which an output may be displayed to the first user 116 of the first computing device 314. The plurality of UI elements 326 may be configured to display user interface (UI) elements for the plurality of products (such as `Product 1, `Product 2', `Product 3', and `Product 4') purchased by the first user 116 of the first computing device 314. In an embodiment, each user interface (UI) element of the plurality of UI elements 326 may correspond to, but is not limited to, an icon, an image portion, or a button included on the display screen 316. In an example, the circuitry 202 may receive the recall information associated with the ‘Product 2’ from the server 106. As described, for example, at 302 and 304 of FIG. 3A, the circuitry 202 may transmit the product information for ‘Product 2’ to the server 106 and accordingly receive the recall information for ‘Product 2’ from the server 106. The recall information may indicate that ‘Product 2’ is being recalled by the manufacturer or the dealer 120 of ‘Product 2’ due to any fault, damage, or problem identified in ‘Product 2’ or in any component or part of ‘Product 2’.

Thereafter, the circuitry 202 may control the display screen 316 to change the display characteristic of the user interface (UI) element 326A of ‘Product 2’ based on the received recall information. In such case, the circuitry 202 may not change the display characteristics for other products (like ‘Product 1’, ‘Product 3’, and ‘Product 4’) for which the recall information may not be received or may not be recalled by the corresponding manufacturer or dealer. As an example, there is shown the user interface (UI) element 326A of ‘Product 2’ may be highlighted in a particular color, and preferably make the user interface (UI) element 326A as non-selectable (or non-editable) to indicate that the recall is initiated by the manufacturer or the dealer 120 for ‘Product 2’. In another example, the circuitry 202 may change the font size of the user interface (UI) element 326A of ‘Product 2’, such as increase or decrease the font size by a predefined amount to indicate that the recall is initiated by the manufacturer or the dealer 120 for ‘Product 2’. In another example, the circuitry 202 may change the font style of the user interface (UI) element 326A of ‘Product 2’ to indicate that the recall is initiated by the manufacturer or the dealer 120. In another example, the circuitry 202 may change the font color of the user interface (UI) element 326A of ‘Product 2’ to different color to indicate that the recall is initiated by the manufacturer or the dealer 120. In another example, the circuitry 202 may freeze or disable the user interface (UI) element 326A for ‘Product 2’, such that the product may not be selected for any transaction or operation (like rent, exchange, sale), until opened (or enabled or fixed) by the manufacturer or the dealer 120 of ‘Product 2’. In another embodiment, the circuitry 202 may remove the product information or remove the user interface (UI) element 326A for ‘Product 2’ from the plurality of UI elements 326, until the recalled product is completely fixed by the manufacturer or the dealer 120 (or by a repair center) or the recall for the disabled product is revoked. Therefore, based on the change in the display characteristics of the user interface (UI) element of the recalled product (like ‘Product 2’), the first user 116 of the first computing device 314 may be efficiently notified about the recalled product. The timely notification about the recalled product may alert the first user 116 to urgently stop the usage of the recalled product, which may further help to reduce any risk of the security issue or privacy issue faced by the first user 116 based on the problems or defects identified in the recalled product.

It may be noted that the number of plurality of UI elements 326 and the plurality of products as shown in FIG. 3A, is presented merely as an example. There may be any number of products and corresponding UI elements may be presented based on the number of products registered on the first computing device 314, without any deviation from the scope of the disclosure.

At 308, one or more requests may be controlled. In an embodiment, the circuitry 202 may control the one or more requests associated with at least one product of the plurality of products based on the received recall information. The control of one or more requests may include, but is not limited to, restriction of one or more requests associated with at least one product of the plurality of products. As an example, the circuitry 202 may restrict (or decline or freeze) one or more requests associated with at least one product (such as the ‘Product 2’) based on the received recall information which may indicate that the product is being recalled by the manufacturer or the dealer 120.

In an embodiment, the circuitry 202 may receive from a second computing device 328 of a second user (such as the second user 118), a first request from the one or more requests, where the first request may be associated with at least one product (such as ‘Product 2’) of the plurality of products. The second computing device 328 may include the second display screen 112 which displays a user interface (similar to the user interface (UI) 318 of the first computing device 314). In an embodiment, circuitry (not shown) of the second computing device 328 may receive, via the user interface (UI), a user input indicative of the first request associated with at least one product registered on the first computing device 314. Based on the received user input, the circuitry of the second computing device 328 may transmit the first request associated with at least one product to the first computing device 314 for further processing.

As an example, in FIG. 3A, the one or more requests 330 are shown. The one or more requests 330 may include, but is not limited to, a rent request 330A, an exchange request 330B, or a sale request 330C for at least one product of the plurality of products. In an example, the received first request may be a request to rent at least one product (such as ‘Product 2’) from the first user 116 for a first time period (for example for certain days, weeks or months). In another example, the received first request may be a request to exchange at least one product from the first user 116 with at least one product (i.e. another product) from the second user 118. In an example, the received first request may be a request to purchase at least one product (such as ‘Product 2’) from the first user 116. As an example, when the received first request is associated with at least one product (such as the ‘Product 2’) for which the recall is initiated by the manufacturer or the dealer 120, the circuitry 202 may restrict (or decline or freeze) the received first request. Based on the restriction or decline of the received first request (i.e. rent, purchase, or exchange) for the recalled product, the disclosed first computing device 314 may ensure, for example, security or privacy for the second user 118 of the second computing device 328, depending upon the problems or defects identified in the recalled product.

Although the exemplary processing pipeline 300 is illustrated as discrete operations steps, such as 302, 304, 306, and 308, the present disclosure is not limited to the steps illustrated. Accordingly, in certain embodiments, such discrete operations may be further divided into additional operations, combined into fewer operations, or eliminated, depending on the particular implementation without detracting from the essence of the disclosed embodiments.

With respect to FIG. 3B, at 310, notification information may be received. In an embodiment, the circuitry 202 may be configured to receive the notification information from the server 106, wherein the notification information may be related to the recall information associated with at least one product of the plurality of products registered on the first computing device 314. The notification information may include, but is not limited to, a push notification via the display screen 316, an electronic mail, a text message, or an instant message. The server 106 may receive the notification information about the recalled product (for example ‘Product 2’) from the electronic device 108 associated with the manufacturer or the dealer 120, and further may store the notification information. The server 106 may further transmit the notification information to the first computing device 314. As an example, there is shown a fourth user interface (UI) element 332 through which an output may be displayed to the first user 116. The fourth user interface (UI) element 332 may be configured to display the notification information which may include, for example, a message as "Product 2 is recalled by the manufacturer. Please contact your nearest dealer for further assistance", as shown in FIG. 3B.

In an embodiment, at 312, acknowledgement information may be transmitted. In an embodiment, the circuitry 202 of the first computing device 314 may further transmit the acknowledgment information for the received recall information to the server 106. As an example, in FIG. 3B, there is shown a fifth user interface (UI) element 334 through which an input may be accepted from the first user 116. The fifth user interface (UI) element 334 may be, for example, a button (such as an “OK” button) that may be configured to receive a user confirmation from the first user 116 to further acknowledge the receipt of the notification information (at 310) related to the recall information associated with at least one product (such as ‘Product 2’) of the plurality of products. In an embodiment, the circuitry 202 may directly transmit the acknowledge information to the electronic device 108 associated with the manufacturer or the dealer 120 of the recalled product. Such acknowledgement information may be an assurance for the server 106 (or for the manufacturer or the dealer 120) that the recall information about the recalled product has reached to the appropriate user (like the first user 116 who has earlier purchased the recalled product) successfully. The first computing device 314 may further assist the first user 116 to take appropriate actions with the recalled product, such as return, repair, or replace.

In an example, such acknowledge information may be helpful for a third-party (like insurance company or services) to provide accurate insurance claims. In an example, if after the transmission of the acknowledgment information of the received recall information, the first user 116 does not follow the required actions (like repair, return, or replace) with the recalled product, the insurance claim (i.e. made later by the first user 116 for any accident or damage with the recalled product) may be denied to the first user 116 for non-compliance. In another example, if after the transmission of the acknowledgment information of the received recall information, the first user 116 follows the required action (like replace the recalled product with a correct product, or repair the recalled product) and an accident occurs with the replaced or repaired product, the insurance claim made by the first user 116 may be processed successfully for the first user 116.

FIGS. 4A and 4B collectively illustrate an exemplary scenario for product recall management on a first computing device, in accordance with an embodiment of the disclosure. FIGS. 4A and 4B are explained in conjunction with elements from FIGS. 1, 2, 3A, and 3B. With reference to FIGS. 4A and 4B there is shown an exemplary scenario 400. The scenario 400 may include a first computing device 402 as an exemplary implementation of the first computing device 102 of FIG. 1. The first computing device 402 may include a display screen 404 as an exemplary implementation of the first display screen 110 of FIG. 1. The display screen 404 may be configured to display a user interface (UI) 406 as an exemplary implementation of the user interface (UI) 212 of FIG. 2. The descriptions of the first computing device 402, the display screen 404, and the user interface (UI) 406 have been discussed previously and hence omitted from herein for the sake of brevity. The user interface (UI) 406 may display a plurality of UI elements 408 (i.e. including a user interface (UI) element or an icon, or an image portion for each product like 'Product 1, 'Product 2', 'Product 3', and 'Product 4') as shown in FIG. 4A. It may be noted that the plurality of UI elements 408 shown in FIG. 4A is merely presented as example and should not be construed as limiting in any sense. The user interface (UI) may display other type of the plurality of UI elements, without any deviation from the scope of the disclosure.

In an embodiment, each of the plurality of UI elements 408 may correspond to each of the plurality of products (such as 'Product 1, 'Product 2', 'Product 3', and 'Product 4') purchased by the first user 116 of the first computing device 402. In an example, the circuitry 202 may receive the recall information associated with ‘Product 2’ as described, for example, in FIG. 3A. Thereafter, the circuitry 202 may be configured to control the display screen 404 to change the display characteristic of a user interface (UI) element associated with ‘Product 2’ based on the received recall information. As an example, in FIG. 4A, there is shown the UI element associated with ‘Product 2’ that may be highlighted or may be frozen (or disabled) to indicate that the recall is initiated by the manufacturer or the dealer 120 for ‘Product 2’, and hence no further transaction or operations (like rent, exchange or sell) may be allowed with respect to ‘Product 2’.

In an embodiment, based on the reception of the recall information, the circuitry 202 may further receive from the server 106, information about one or more operations associated with the product of the plurality of products for which the recall has been initiated. The one or more operations may include, but is not limited to, a return operation, a replace operation, a refund operation, or repair operation associated with the product of the plurality of products. In an example, if the received information about one or more operations corresponds to the return operation associated with the product, the circuitry 202 may initiate return of the product to the manufacturer or the dealer 120. In another example, if the received information about one or more operations corresponds to the refund operation associated with the product, the circuitry 202 may initiate the refund of cost of the recalled product to the first user 116 (via the first computing device 402) by the manufacturer or the dealer 120. In an example, if the received information about one or more operations corresponds to the replace operation associated with the product, the circuitry 202 may initiate the replace operation to replace the recalled product from the manufacturer or the dealer 120. In another example, if the received information about one or more operations corresponds to the repair operation associated with the product, the circuitry 202 may initiate the repair work associated with the product by the manufacturer or the dealer 120 (or by a repair center designated by the manufacturer or the dealer 120). In another embodiment, the circuitry 202 may retrieve the information about the one or more operations for the recalled product from the memory 204, rather than receiving from the server 106. For certain products, all the operations (like return, refund, replace, and repair) as shown in FIG. 4A, may not be allowed. For example, for a particular product only replace and repair may be allowed, not the return and refund.

In an embodiment, the circuitry 202 may further control the display screen 404 to display the information about one or more operations allowed or associated with the recalled product (such as ‘Product 2’) as shown in FIG. 4A. For example, the user interface (UI) 406 may display a plurality of UI elements (like icons, selectable buttons, or image portions) for each of the one or more operations associated with the recalled product. The circuitry 202 may be further configured to receive, via the user interface (UI) 406, a second user input indicative of a selection of a first operation from the one or more operations. As an example, the second user input may be accepted from the first user 116 though a first user interface (UI) element 410, and a second user interface (UI) element 412. The first user interface (UI) element 410 may be configured to receive the second user input indicative of the selection of the first operation from the one or more operations. For example, first user 116 may select or touch (i.e. the second user input) a particular portion or icon of the first user interface (UI) element 410 for the selection of the first operations as ‘Return Operation’, as shown in FIG. 4A. The second user interface (UI) element 412 may be, for example, a button (such as a ‘Select’ Button) that may be configured to receive a user confirmation to select the first operation from the one or more operations. The first user 116 may select (i.e. touch or press) the second user interface (UI) element 412 to finally confirm the first operation (i.e. ‘Return Operation’) selected via the first user interface (UI) element 410.

In an embodiment, the circuitry 202 may further determine a first geolocation of the first computing device 402. The first geolocation of the first computing device 402 may correspond to a current geolocation where the first computing device 402 may be located at present or in use. In an embodiment, the first computing device 402 may receive a user input (for example, via the I/O device 206) indicative of the first geolocation of the first computing device 402. The user input may include, but is not limited to, location coordinates (in latitude and longitude), ZIP code, a landmark, or an address.

In an embodiment, the first computing device 402 may include one or more sensors such as a location sensor (not shown), which may be configured to determine the first geolocation of the first computing device 402. The location sensor may include suitable logic, circuitry, code, and/or interfaces that may be configured to automatically determine the first geolocation of the first computing device 402. An example of the location sensor may include, but are not limited to, a Global Navigation Satellite System (GNSS)-based sensor of the first computing device 402. Examples of the GNSS-based sensor may include, but are not limited to, global positioning sensor (GPS), Global Navigation Satellite System (GLONASS), or other regional navigation systems and/or sensors. A person with ordinary skill in the art will understand that the scope of the present disclosure may not be limited to the implementation of the location sensor incorporated in its entirety or at least partially in the first computing device 402. In certain embodiments, the location sensor and the first computing device 402 may be implemented as two separate entities, without a departure from the scope of the present disclosure.

In an embodiment, the first geolocation may be determined based on at least one of Global Positioning System (GPS) information or an Internet Protocol (IP) address associated with the first computing device 402. The first computing device 402 may include an integrated location sensor, for example, a Global Positioning System (GPS) sensor, that may be configured to determine the first geolocation based on geolocation information such as, but not limited to, a latitude, a longitude, and an altitude associated with the first geolocation. The first computing device 402 may automatically determine the first geolocation of the first computing device 402 based on the geolocation information captured by the GPS sensor. In some embodiments, the first computing device 402 may automatically determine the first geolocation based on the IP address associated with the first computing device 402.

In an embodiment, based on the determined first geolocation, the circuitry 202 may generate a list of manufacturers or dealers of the recalled product of the plurality of products, where the centers or offices of the list of manufacturers or dealers may be located within a threshold distance from the first geolocation of the first computing device 402. In other words, the circuitry 202 may determine the centers or the offices of the list of manufacturers or dealers of the recalled product which may be proximate to the current location of the first computing device 402. The threshold distance may correspond to a predefined distance such as within certain miles or kilometers (such as, but not limited to, within 1 mile, within 3 miles, within 10 miles or any other distance). In another embodiment, the circuitry 202 may retrieve the list of manufacturers or dealers related to the recalled product from the memory 204 or receive from the server 106 based on the selection of the first operation (like ‘Return operation’) for the recalled product (i.e. ‘Product 2’). In an embodiment, the circuitry 202 may be configured to receive a user input (via the I/O device 206) from the first user 116, to set the threshold distance that may determine the proximity of the manufacturer or dealer 120 with respect to current location of the first computing device 402. In another embodiment, the circuitry 202 may be configured to set a default threshold value (such as within 5 miles).

In an embodiment, the circuitry 202 may further control the display screen 404 to display the generated list of manufacturers or dealers of the recalled product. As an example, as shown in FIG. 4A, the display screen 404 may display generated list that may include a dealer name and a distance of corresponding dealer from the first geolocation such as ‘Dealer 1 (0.3 miles Away)’, ‘Dealer 2 (1.2 miles Away)’, ‘Dealer 3 (0.6 miles Away)’ and ‘Dealer 4 (3 miles Away)’.

In an embodiment, the circuitry 202 may automatically determine the manufacturer or the dealer 120 from the generated (or retrieved) list of manufacturers or dealers, for one or more operations associated with the recalled product. The manufacturer or the dealer 120 may be determined based on at least one of a proximity distance between the first geolocation of the first computing device 102 and the selected or determined manufacturer or the dealer 120, an availability of the manufacturer or the dealer 120, or a feedback rating value associated with the manufacturer or the dealer 120.

In an embodiment, the circuitry 202 may be configured to receive a third user input to select the manufacturer or the dealer 120 from the generated list of manufacturers or dealers, for one or more operations associated with the recalled product. As an example, the third user input may be accepted from the first user 116 though a third user interface (UI) element 414 and a fourth user interface (UI) element 416 as shown in FIG. 4A. The third user interface (UI) element 414 may be configured to receive the third user input indicative of the selection of the manufacturer or the dealer 120 from the generated list. The first user 116 may select or touch a particular portion or icon of the third user interface (UI) element 414 to select the manufacturer or the dealer 120 (like ‘Dealer 1’) from the generated list of manufacturers or dealers as shown, for example, at FIG. 4A. The fourth user interface (UI) element 416 may be, for example, a button (such as a ‘Submit’ Button) that may be configured to receive a user confirmation from the first user 116 to select the manufacturer or the dealer 120 to execute the selection first operation (like ‘Return Operation’) from one or more operations. The first user 116 may select (i.e. touch or press) the fourth user interface (UI) element 416 to finally confirm the manufacturer or the dealer 120 (i.e. ‘Dealer 1’) that may be selected via the third user interface (UI) element 414.

In an embodiment, the circuitry 202 may be further configured to receive from the server 106, contact information associated with the determined manufacturer or the dealer 120 of the recalled product of the plurality of products based on the received second user input indicative of the selection of the first operation. In another embodiment, the circuitry 202 may receive from the server 106, the contact information associated with the selected manufacturer or the dealer 120 based on the third user input. The contact information may include, but is not limited to, a contact number, an address, or schedule information associated with the manufacturer or the dealer 120 of the recalled product. In an example, the circuitry 202 may control the display screen 404 to display the contact information of the manufacturer or the dealer 120. The contact number may be related to a phone number associated with the center or office of the manufacturer or the dealer 120 of the recalled product. The address may be related to location information associated with the center or the office of the selected manufacturer or the dealer 120 of the recalled product. For example, the address may indicate, but is not limited to, a name of a center/office, a street name/number, a plot number, a locality, a city, or a state. The schedule information may be related to availability of timeslots at the manufacturer or the dealer 120 for the completion of one or more operations for the recalled product. For example, the schedule information may indicate a set of timeslots available on a certain day or date. The first user 116 of the first computing device 402 may be allowed to choose a particular timeslot from the set of timeslots to perform the selected operations/transaction (replace, refund, repair, or replace) for the recalled product with the manufacturer or the dealer 120

In an embodiment, the circuitry 202 may receive, from an electronic device (such as the electronic device 108) or from the server 106 associated with the selected manufacturer or the dealer 120 of the recalled product, information about the set of timeslots available at the selected center/office of the manufacturer or the dealer 120 for the completion of one or more operations/transactions for the recalled product. As an example, the selected center/office of the manufacturer or the dealer 120 may be ‘Dealer1 - 0.3 miles Away’ as ‘Dealer 1’ may be closest in comparison to centers/offices of other manufactures or dealers of the recalled product from the current location of the first computing device 402. In such case, the circuitry 202 may receive from the electronic device 108 (or from the server 106) associated with the manufacturer or the dealer 120 (such as the ‘Dealer1’), the information about the set of timeslots available for the completion of the one or more operations for the recalled product. As an example, in FIG. 4B, there is shown the set of timeslots for a certain day (such as, ‘6 May 2021’). Examples of the set of timeslots on a particular date (like "6 May 2021") in FIG. 4B may include, but are not limited to, `1:00 PM -1:30 PM', `3:00 PM - 3:30 PM', "5.30 PM - 6:00 PM', or `6:00 PM - 6:30 PM'.

In an embodiment, the circuitry 202 may receive, via the user interface (UI) 406, a fourth user input to select a first timeslot from the set of timeslots. The circuitry 202 may further transmit the received fourth user input to the electronic device 108 of the selected manufacture or the dealer 120. The first timeslot may be a user preferred timeslot for completion of one or more operations for the recalled product of the plurality of products. In other words, the first timeslot may be the user preferred timeslot to visit the selected center or office of the manufacturer or the dealer 120 to perform selected operation (like ‘Return Operation’) with the recalled product (`Product 2). As an example, the fourth user input may be accepted from the first user 116, via a fifth user interface (UI) element 418 and a sixth user interface (UI) element 420. The fifth user interface (UI) element 418 may be configured to receive the fourth user input indicative of the selection of the first timeslot. The first user 116 may select or touch a particular portion or icon of the fifth user interface (UI) element 418 to select the first timeslot (like ‘3:00 PM - 3.30 PM’) from the set of timeslots as shown, for example, at FIG. 4B. The sixth user interface (UI) element 420 may be, for example, a button (such as a ‘Confirm’ Button) that may be configured to receive a user confirmation to select the first timeslot. The first user 116 may select (i.e. touch or press) the sixth user interface (UI) element 420 to finally confirm the first timeslot (i.e. `3:00 PM - 3:30 PM') Dealer 1') that may be selected via the fifth user interface (UI) element 418. The circuitry 202 may be further configured to transmit information about the selected timeslot (as the fourth user input) to the selected manufacturer or the dealer 120 (like ‘Dealer 1’). In another embodiment, the circuitry 202 may be configured to automatically determine the first timeslot from the set of timeslots for completion of one or more operations for the recalled product of the plurality of products.

Based on the selection of the first operation (like ‘Return Operation’), the manufacturer or the dealer 120 of the recalled product, and the selected available first timeslot, the first user 116 may return the recalled product at the selected office or center of the manufacturer or the dealer 120 at the selected first timeslots. Based on the execution of the first operation from one or more operations of the recalled product, the circuitry 202 may further delete, from the user interface (UI) 406, the product information and the corresponding user interface (UI) element associated with the returned product (like ‘Product 2’) of the plurality of products. As an example, based on the deletion of the product information of the return product, the plurality of UI elements 408 may display the information about the plurality of products (such as 'Product 1, 'Product 3', and 'Product 4') purchased by the first user 116 of the first computing device 402 as shown, in FIG. 4B. In another example, if the selected operation for the recalled product is ‘Replace Operation’, the circuitry 202 may update the product information of the recalled product with the product information of a new product which may be a replacement of the recalled product. In another example, if the selected operation for the recalled product is ‘Repair Operation’, the circuitry 202 may update the product information to indicate that the recalled product is now repaired or troubleshooted. In such cases where the selected operation is either replaced or repaired, the circuitry 202 may further control the display screen 404 to change the display characteristics of a user interface (UI) element of the replaced/repaired product, such that the replaced/repair product and the associated user interface (UI) element may be enabled or activated for upcoming requests (like rent, exchange, or purchase).

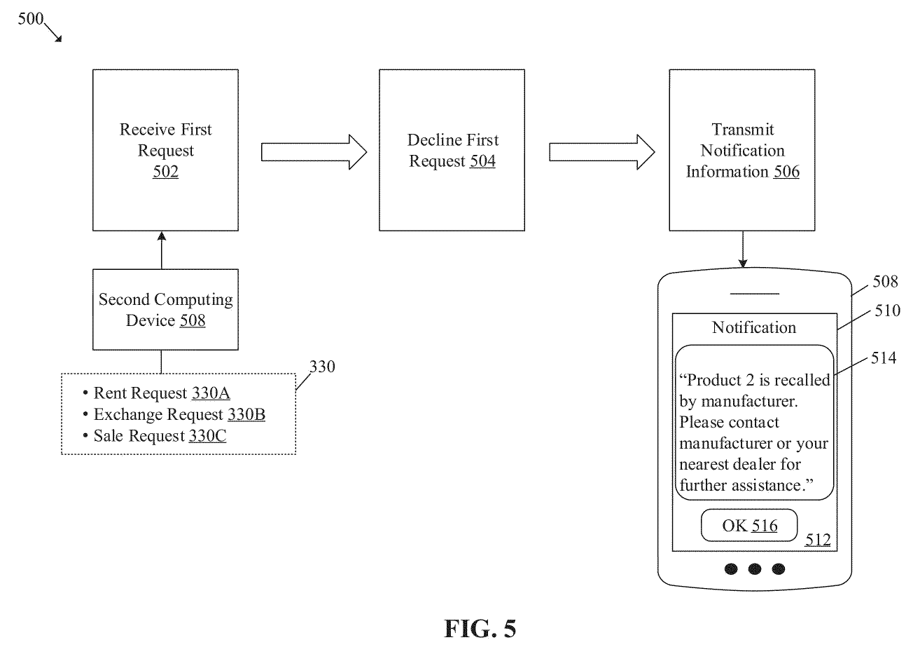

FIG. 5 is a diagram that illustrates an exemplary processing pipeline to decline one or more requests based on recall information, in accordance with an embodiment of the disclosure. With reference to FIG. 5 there is shown an exemplary processing pipeline 500. The exemplary processing pipeline 500 is explained in conjunction with elements from FIGS. 1, 2, 3A, 3B, 4A, and 4B. The operations illustrated as exemplary steps 502 to 506 may be implemented by the first computing device 102 shown in FIG. 1, or the circuitry 202 shown in FIG. 2. The operations of the exemplary processing pipeline 500 may start at 502.

At 502, a first request may be received. In an embodiment, the circuitry 202 may receive from a second computing device 508 of a second user (such as the second user 118), the first request from one or more requests 330 associated with at least one product of the plurality of products registered on the first computing device 402. The receipt of the first request is described, for example, at 308 in FIGS. 3A, and 3B.

At 504, the first request may be declined. In an embodiment, the circuitry 202 may decline the received first request based on the received recall information for the recalled product of the plurality of products. In an example, the circuitry 202 may receive the recall information with respect to ‘Product 2’ from the manufacturer or the dealer 120 or from the server 106 (i.e. as described, for example, at 304 in FIG. 3A). In such an example, when the circuitry 202 receives the first request (i.e. rent request, exchange request, or sale request) for the recalled product (like ‘Product 2’) from the second computing device 508 of the second user 118, the circuitry 202 may be configured to decline or reject the received first request for the product which is already recalled from the manufacturer or the dealer 120 due to any fault or issue identified in the product (or related components). Due to the decline or rejection of such requests for the recalled product, the disclosed first computing device 402 may reduce the risk of problems related to security or privacy for the second user 118 with the usage of the recalled product.

At 506, notification information may be transmitted. In an embodiment, the circuitry 202 may transmit the notification information associated with the recall information for the recalled product to the second computing device 508. The notification information may include, but is not limited to, a push notification, an electronic mail, a text message, an or instant message. The circuitry 202 may receive the notification information from the server 106, as described, for example, at 310 in FIG. 3B. The notification information transmitted to the second computing device 508 may indicate to the second user 118 that the product for which the first request (like rent, exchange, or sale) is received is already recalled by the manufacturer or the dealer 120. As an example, when the circuitry 202 declines the first request, the circuitry 202 may transmit the notification information to the second computing device 508 in order to alert the second user 118 about the recall initiated by the manufacturer or the dealer 120 for the product. The second computing device 508 may include a display screen 510 (i.e. similar to second display screen 112 of FIG. 1) which may display a user interface (UI) 512. The user interface (UI) 512 may include a first user interface (UI) element 514 and a second user interface (UI) element 516 as shown, for example, in FIG. 5. As an example, in FIG. 5, there is shown the first user interface (UI) element 514 through which an output may be displayed to the second user 118. The first user interface (UI) element 514 may be configured to display the notification information to the second user 118, which may include a message, for example, "Product 2 is recalled by manufacturer. Please contact manufacturer or your nearest dealer for further assistance." The second user interface (UI) element 516 may be configured to accept input from the second user 118. The second user interface (UI) element 516 may be, for example, a button (such as an OK button) that may be configured to receive a user confirmation to acknowledge the receipt of the notification information related to the recall information for the recalled product. The second user 118 may select the second user interface (UI) element 516 to transmit the acknowledgement for the received notification information back to the first computing device 402.

In an embodiment, the circuitry 202 may be further configured to transmit the notification information (i.e. associated with the recall information for the recalled product) to the second computing device 508 of the second user 118 who may have already rented the product from the first user 116 for a first time period (for example for few days, weeks, or months). The second user 118 may have rented the product from the first user 116 for the first time period, before the initiation of the recall for the same product by the manufacturer or the dealer 120. The notification information may be transmitted to the second computing device 508 to inform the second user 118 that the rented product (like ‘Product 2’) has been recalled by the manufacturer or the dealer 120 and therefore, one or more operations (like repair, return, replace, or refund) has to be performed at the end of the second user 118. The circuitry 202 may further transmit a request, to the second computing device 508 of the second user 118, to select one of: the first user 116, the manufacturer, or the dealer 120, to return the recalled product of the plurality of products. In an embodiment, the circuitry of the second computing device 508 of the second user 118 may receive, via the user interface (UI) 512, the request to select one of: the first user 116, the manufacturer, or the dealer 120 to return the recalled product. As an example, an input may be accepted from the second user 118 through the first user interface (UI) elements 514 to select one of: the first user 116, the manufacturer, or the dealer 120 to return the recalled product of the plurality of products. The second user interface (UI) element 516 (for example, a button) may be configured to receive a user confirmation of the selection.

In an embodiment, the circuitry 202 of the first computing device 402 may further transmit to the second computing device 508 of the second user 118, contact information associated with one of: the first user 116, the manufacturer, or the dealer 120 of the recalled product based on the selection, to further perform one or more operations (for example return). The contact information may include, but is not limited to, a contact number, an address, or schedule information associated with one of: the first user 116, the manufacturer, or the dealer 120 of the recalled product. The circuitry 202 may receive from the server 106, the contact information associated with the manufacturer or the dealer 120 of the recalled product of the plurality of products, as described, for example, in FIGS. 4A and 4B.

In an embodiment, the circuitry 202 may transmit the contact information associated with the first user 116 to the server 106, based on a received user input. The circuitry 202 may receive, via the user interface (UI) 212, the user input indicative of the contact information associated with the first user 116. The second computing device 508 may further receive, from the server 106, the contact information associated with the first user 116. The contact information may include, but is not limited to, a contact number, an address, or schedule information associated with the first user 116. In an example, the circuitry of the second computing device 508 may further display the received contact information on the display screen 510 of the second computing device 508. The schedule information may be related to availability of timeslots at the end of the first user 116 for completion of the return operation for the recalled product. In case of the selection of the manufacturer or the dealer 120, the schedule information may be related to availability of timeslots at the end of the manufacturer or the dealer 120 for the completion of the return operation for the recalled product.

In an embodiment, the circuitry of the second computing device 508 may control the display screen 510 to display the contact information associated with the at least one of the first user 116, or the manufacturer, or the dealer 120 of the recalled product. The circuitry of the second computing device 508 may further receive from the second user 118, the user inputs to select one of the first user 116, the manufacturer, or the dealer 120 (like from the generated list manufacturers or dealers), for the return operation. Similarly, the circuitry of the second computing device 508 may further receive from the second user 118, the user inputs to select the first timeslot to complete the return operation. The details of the selection of the manufacturer or the dealer 120 and the first timeslot, are described, for example, in FIGS. 4A, and 4B.

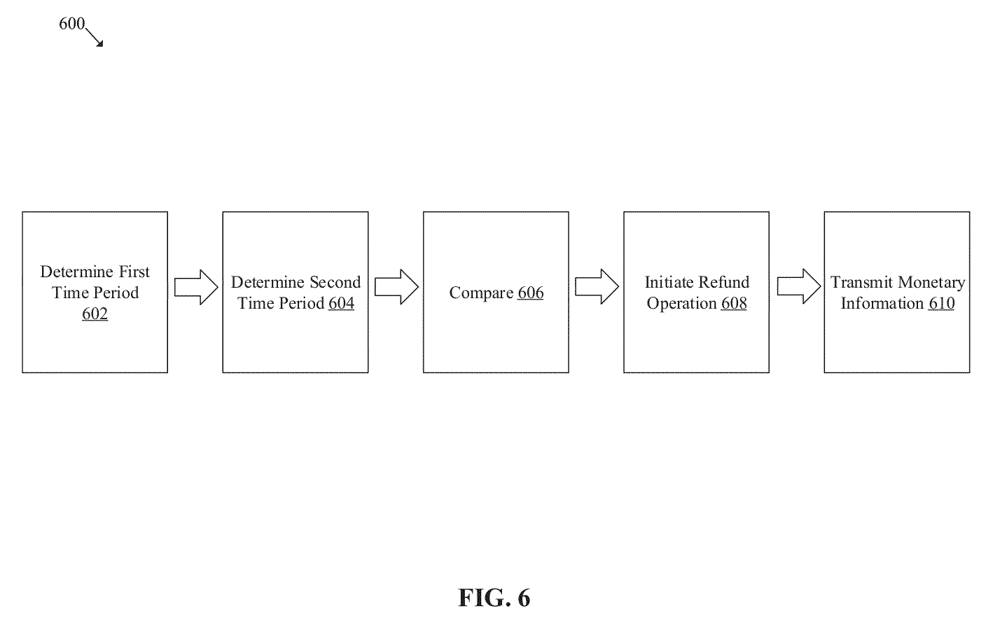

FIG. 6 is a diagram that illustrates an exemplary processing pipeline for a refund operation based on recall information, in accordance with an embodiment of the disclosure. With reference to FIG. 6 there is shown an exemplary processing pipeline 600. The exemplary processing pipeline 600 is explained in conjunction with elements from FIGS. 1, 2, 3A, 3B, 4A, 4B, and 5. The exemplary operations 602 to 610 may be implemented by the first computing device 102 shown in FIG. 1, or the circuitry 202 shown in FIG. 2. The operations of the exemplary processing pipeline 600 may start at 602.

At 602, a first time period may be determined. In an embodiment, the circuitry 202 may determine the first time period for which at least one product of the plurality of products is rented to a second user (such as the second user 118) of a second computing device (such as the second computing device 104) from the first user (such as the first user 116). For example, the first time period for which at least one product is rented to the second user 118 may be, but is not limited to, certain days, certain weeks, certain months, or certain years. In an embodiment, the circuitry 202 may receive, via the user interface (UI) 212, a user input indicative of the first time period for which at least one product is rented to the second user 118. The circuitry 202 may transmit information about the received first time period for which at least one product is rented to the second user 118 to the server 106 or to the second computing device 508. The server 106 or the second computing device 508 may store the first time period for which the product is rented to the second user 118. In another embodiment, the first time period for renting may be stored in the product information for the product. The circuitry 202 may determine the first time period based on the retrieved product information stored in the memory 204. In another embodiment, the circuitry 202 may automatically determine or set the first time period (for example four weeks) for which the product is rented to the second user 118.

At 604, a second time period may be determined. In an embodiment, the circuitry 202 may determine the second time period at which the recall information associated with the recalled product of the plurality of products is received. For example, the second time period at which the recall information is received may include, but is not limited to, a particular time on a certain day. In an embodiment, the server 106 may receive from the electronic device 108 associated with manufacturer or the dealer 120, a user input indicative of the second time period at which the recall information is received. The server 106 may store information about the second time period at which the recall information is received. The circuitry 202 may further receive from the server 106, the stored information about the second time period at which the recall information is received or the recall for the product is initiated.

At 606, the first time period and the second time period may be compared. In an embodiment, the circuitry 202 may compare the first time period for which the product is rented to the second user 118 and the second time period at which the recall information is received. For example, in case the second time period at which the recall information is received falls within the range of the first time period for which the product is rented to the second user 118, the control may pass to 608. Otherwise, no action may be needed. For example, if the product is rented for 1 month on ‘May 1, 2020’ (i.e. first time period), and the recall information is received on ‘May 20, 2020’ (i.e. second time period), this indicates that the second time period is within the range of the first time period after which the renting of the product to the second user 118 may expire.

At 608, a refund operation may be initiated. In an embodiment, the circuitry 202 may process and/or initiate, for the second user 118, the refund operation associated with the recall, based on the comparison between the first time period and the second time period. In an example, the first time period for which the product is rented to the second user 118 may be one month (such as from ‘May 1, 2020’ till ‘Jun. 1, 2020’) and the second time period on which the recall information for the rented product is received may be ‘May 20, 2020’. Based on the comparison, the circuitry 202 may determine that the second time period is within the first time period and therefore a refund (i.e. refund operation) may be provided to the second user 118 for the remaining days after recall is initiated for the rented product. Thus, the circuitry 202 of the first computing device 402 may process or initiate, for the second user 118, the refund operation associated with the recalled product for the remaining time period (such as for 11 days between ‘May 21, 2020’ till ‘Jun. 1, 2020’).

In the refund operation, the circuitry 202 may generate monetary information based on the remaining time period and cost of renting the product to the second user 118. For example, in case the cost of renting a particular product for one month is 1000 dollars and the remaining time period is 11 days, then the circuitry 202 may determine the monetary information approximately as 367 dollars. In an embodiment, the cost of renting of the plurality of products for one month may be predefined and stored in the memory 204. In another embodiment, the cost of renting of the plurality of products may be updated regularly based on demand and supply, and received from the server 106. In an embodiment, the monetary information related to the refund operation may include, but is not limited to, a time period for which the refund is to be issued, an amount or cost associated with the refund, or a mode of payment associated with the refund. The time period for which the refund is to be issued may be related to the remaining time period (such as a time period of 11 days). The amount or cost associated with the refund may be related to a monetary value associated with the refund operation (such as an amount or cost in a particular currency). The mode of payment associated with the refund may be related to a payment technique that may be used to issue the refund (such as using a predefined wallet, a payment using bank transfer, payment using a payment card, or payment using redeemable points).

At 610, the monetary information may be transmitted. In an embodiment, the circuitry 202 may transmit the generated monetary information related to the refund operation to the second computing device 104 of the second user 118. In an embodiment, the monetary information may be transferred to a bank account or a payment wallet associated with the second user 118.

Therefore, as described (for example in FIGS. 3A, 3B, 4A, 4B, 5, and 6), based on the real-time reception of the recall information and the notification information from the server 106, change of the display characteristic of information about the recalled product, control of one or more requests (i.e. rent, exchange, or sale) for the recalled product, control of different operations (like return, replace, refund, or repair) for the recalled product, selection of manufactures/dealers, update of the product information, and transmission of the notification information and the monetary information for the recalled product, the disclosed first computing device 102 may perform effective management of the recall products and significantly reduce the risks with respect to the issues which may be caused by the continuous usage of the product after the recall.

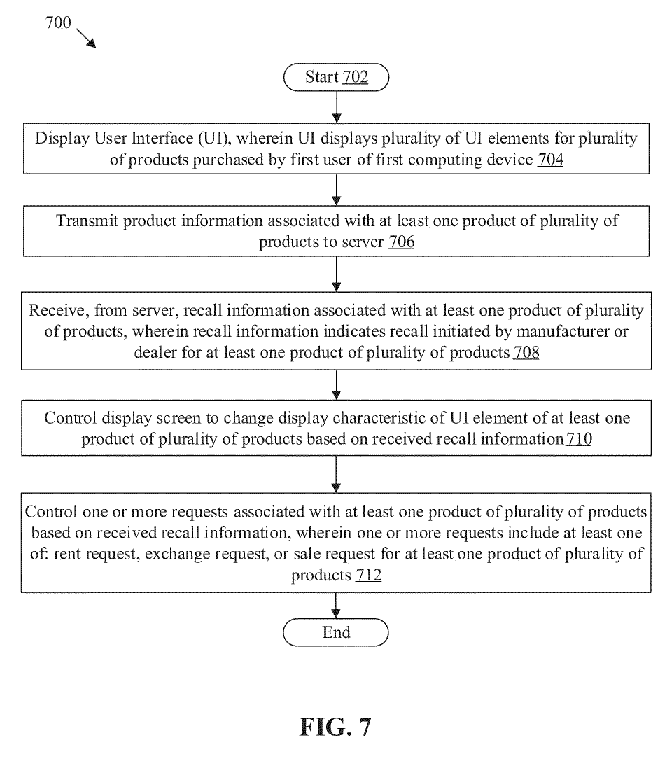

FIG. 7 is a flowchart that illustrates an exemplary method for product recall management on a first computing device, in accordance with an embodiment of the disclosure. With reference to FIG. 7, there is shown a flowchart 700. The flowchart 700 is described in conjunction with FIGS. 1, 2, 3A, 3B, 4A, 4B, 5, and 6. The operations from 702 to 712 may be implemented by the first computing device 102 shown in FIG. 1, or the circuitry 202 shown in FIG. 1. The operations of the flowchart 700 may start at 702 and proceed to 704.

At 704, a user interface (such as the user interface (UI) 212) may be displayed. In an embodiment, a display screen (such as the display screen 210) may be configured to display the user interface (UI) 212 based on the control of the circuitry 202. The user interface (UI) 212 may display a plurality of UI elements for a plurality of products purchased by a first user (such as the first user 116) of the first computing device 102.

At 706, product information associated with at least one product of the plurality of products may be transmitted. In an embodiment, the circuitry 202 may be configured to transmit the product information associated with at least one product of the plurality of products to a server (such as the server 106). In an embodiment, the transmitted product information may be further stored in a database that may be hosted on the server 106. For example, the product information associated with at least one product of the plurality of products may include, but is not be limited to, a product identification number, a product serial number, a batch number, a product name, or product license information. The details associated with the transmission of the product information, are provided, for example, at 302 in FIG. 3A.

At 708, recall information associated with at least one product of the plurality of products may be received. In an embodiment, the circuitry 202 may be configured to receive from the server 106, the recall information associated with at least one product of the plurality of products. The recall information may indicate a recall initiated by a manufacturer or a dealer (such as the manufacturer or the dealer 120) for at least one product of the plurality of products. The details associated with the reception of the recall information, are provided, for example, at 304 in FIG. 3A.

At 710, the display screen 210 may be controlled. In an embodiment, the circuitry 202 may be configured to control the display screen 210 to change a display characteristic of a UI element of at least one product of the plurality of products based on the received recall information. For example, the display characteristic of the UI element of at least one product of the plurality of products may include, but is not limited to, a highlighting, a font size, a font style, or a foreground color. The details associated with the control of the display screen to change the display characteristic, are provided, for example, at 306 in FIG. 3A and in FIG. 4A.

At 712, one or more requests (such as, the one or more requests 330) associated with at least one product of the plurality of products may be controlled. In an embodiment, the circuitry 202 may be configured to control of one or more requests 330 associated with at least one product of the plurality of products based on the received recall information. The one or more requests 330 may include, but are not limited to, a rent request (such as the rent request 330A), an exchange request (such as, the exchange request 330B), or a sale request (such as the sale request 330C) for at least one product of the plurality of products. For example, the control of one or more requests 330 may include restriction of one or more requests 330 associated with at least one product of the plurality of products. The details associated with the control of the one or more requests 330, are provided, for example, in FIGS. 3A, 3B, 5 and 6. Control may pass to end.

Although the flowchart 700 is illustrated as discrete operations, such as 704, 706, 708, 710, and 712, the disclosure may not be so limited. Accordingly, in certain embodiments, such discrete operations may be further divided into additional operations, combined into fewer operations, or eliminated, depending on the particular implementation without detracting from the essence of the disclosed embodiments.

Various embodiments of the disclosure may provide a non-transitory, computer-readable medium and/or storage medium, and/or a non-transitory machine readable medium and/or storage medium stored thereon, a set of instructions executable by a machine and/or a computer (such as, the first computing device 102) for product recall management. The first computing device 102 may include a display screen (such as, the display screen 210) which displays a user interface (UI) (such as, the user interface (UI) 212). The user interface (UI) 212 may display a plurality of UI elements for a plurality of products purchased by a first user (such as, the first user 116) of the first computing device 102. The set of instructions may be executable by the machine and/or the computer to perform the operations that may include transmission of product information associated with at least one product of the plurality of products to a server (such as, the server 106). The operations may further include reception of, from the server 106, recall information associated with the at least one product of the plurality of products. The recall information may indicate a recall initiated by a manufacturer or a dealer (such as, the manufacturer or the dealer 120) for the at least one product of the plurality of products. The operations may further include control of the display screen 210 to change a display characteristic of a user interface (UI) element of the at least one product of the plurality of products based on the received recall information. The operations may further include control of one or more requests (such as, the one or more requests 330) associated with the at least one product of the plurality of products based on the received recall information. The one or more requests 330 may include at least one of: a rent request (such as the rent request 330A), an exchange request (such as, the exchange request 330B), or a sale request (such as the sale request 330C) for the at least one product of the plurality of products.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

What is claimed is:

1. A first computing device, comprising:
a display screen which displays a user Interface (UI), wherein the UI displays a plurality of UI elements for a plurality of products purchased by a first user of the first computing device; and
a circuitry communicatively coupled to a server and the display screen, wherein the circuitry:
transmits product information associated with at least one product of the plurality of products to the server;
receives, from the server, recall information associated with the at least one product of the plurality of products, wherein the recall information being indicative of a recall initiated by a manufacturer or a dealer for the at least one product of the plurality of products;
controls the display screen to change a display characteristic of a UI element of the at least one product of the plurality of products based on the received recall information; and
controls one or more requests associated with the at least one product of the plurality of products based on the received recall information, wherein the one or more requests comprise at least one of: a rent request, an exchange request, or a sale request for the at least one product of the plurality of products.

2. The first computing device according to claim 1, wherein the display characteristic of the UI element of the at least one product of the plurality of products comprises at least one of: a highlighting, a font size, a font style, a foreground color, or an uneditable UI element.

3. The first computing device according to claim 1, wherein the control of the one or more requests comprises restriction of the one or more requests associated with the at least one product of the plurality of products.

4. The first computing device according to claim 1, wherein the product information associated with the at least one product of the plurality of products comprises at least one of: a product identification number, a product serial number, a batch number, a product name, or product license information.

5. The first computing device according to claim 1, wherein the circuitry further:
receives, via the UI, a first user input indicative of the product information associated with the at least one product of the plurality of products; and
transmits the product information associated with the at least one product to the server, based on the received first user input.

6. The first computing device according to claim 1, wherein the server receives the recall information from an electronic device associated with the manufacturer or the dealer, and further stores the received recall information associated with the at least one product of the plurality of products.

7. The first computing device according to claim 1, wherein the circuitry further receives, from the server, notification information related to the recall information associated with the at least one product of the plurality of products, and
wherein the notification information comprises at least one of: a push notification via the UI, an electronic mail, a text message, or an instant message.

8. The first computing device according to claim 1, wherein the circuitry further:
receives, from the server, information about one or more operations associated with the at least one product of the plurality of products for which the recall is initiated;
receives, via the UI, a second user input indicative of a selection of a first operation from the one or more operations;
receives, from the server, contact information associated with the manufacturer or the dealer of the at least one product of the plurality of products based on the received second user input, wherein the contact information comprises at least one of: a contact number, an address, or schedule information associated with the manufacturer or the dealer of the at least one product of the plurality of products; and
controls the display screen to display the contact information associated with the manufacturer or the dealer of the at least one product of the plurality of products.

9. The first computing device according to claim 8, wherein the one or more operations comprise at least one of: a return operation, a replace operation, a refund operation, or repair operation associated with the at least one product of the plurality of products.

10. The first computing device according to claim 9, wherein the circuitry further:
receives, via the UI, the second user input indicative of the selection of the return operation associated with the at least one product of the plurality of products; and
deletes, from the UI, the product information and the corresponding UI element associated with the at least one product of the plurality of products based on the selection of the return operation.

11. The first computing device according to claim 9, wherein the circuitry further:
determines a first geolocation of the first computing device;
generates a list of manufacturers or dealers of the at least one product of the plurality of products, located within a threshold distance from the first geolocation of the first computing device;
receives a third user input to select the manufacturer or the dealer from the generated list manufacturers or dealers, for the one or more operations associated with the at least one product;
receives, from an electronic device associated with the selected manufacturer or the dealer of the at least one product, a set of timeslots available for completion of the one or more operations for the at least one product of the plurality of products;
receives a fourth user input to select a first timeslot from the set of timeslots; and
transmits the received fourth user input to the electronic device of the selected manufacture or the dealer.

12. The first computing device according to claim 11, wherein the first geolocation is determined based on at least one of: Global Positioning System (GPS) information or an Internet Protocol (IP) address associated with the first computing device.

13. The first computing device according to claim 9, wherein the circuitry further:
determines a first geolocation of the first computing device;
generates a list of manufacturers or dealers of the at least one product of the plurality of products, located within a threshold distance from the first geolocation of the first computing device;
determines the manufacturer or the dealer from the generated list manufacturers or dealers, for the one or more operations associated with the at least one product; and
determines a first timeslot from a set of timeslots for completion of the one or more operations for the at least one product of the plurality of products.

14. The first computing device according to claim 1, wherein the circuitry further transmits acknowledgment information for the received recall information, to the server.

15. The first computing device according to claim 1, wherein the circuitry further:
receives, from a second computing device of a second user, a first request from the one or more requests associated with the at least one product of the plurality of products;
declines the received first request based on the received recall information for the at least one product of the plurality of products; and
transmits notification information associated with the recall information for the at least one product of the plurality of products to the second computing device, wherein the notification information comprises at least one of: a push notification, an electronic mail, a text message, or an instant message.

16. The first computing device according to claim 1, wherein the circuitry further:
transmits notification information associated with the recall information for the at least one product of the plurality of products to a second computing device of a second user who has rented the at least one product from the first user for a first time period, wherein the notification information comprises at least one of: a push notification, an electronic mail, a text message, or an instant message; and
transmits a request, to the second computing device of the second user, to select one of: the first user, the manufacturer, or the dealer to return the at least one product of the plurality of products; and
transmits, to the second computing device of the second user, contact information associated with one of: the first user, the manufacturer, or the dealer of the at least one product of the plurality of products based on the selection, wherein the contact information comprises at least one of a contact number, an address, or schedule information associated with one of: the first user, the manufacturer, or the dealer of the at least one product of the plurality of products.

17. The first computing device according to claim 16, wherein the circuitry further:
determines a second time period at which the recall information associated with the at least one product of the plurality of products is received;
compares the first time period for which the at least one product is rented to the second user, and the second time period at which the recall information is received;
initiates, for the second user, a refund operation associated with the at least one product of the plurality of products based on the comparison; and
transmits monetary information related to the refund operation to the second computing device of the second user.

18. A method, comprising:
in a first computing device which includes a display screen which displays a user Interface (UI), wherein the UI displays a plurality of UI elements for a plurality of products purchased by a first user of the first computing device; and
transmitting product information associated with at least one product of the plurality of products to a server;
receiving, from the server, recall information associated with the at least one product of the plurality of products, wherein the recall information indicates a recall initiated by a manufacturer or a dealer for the at least one product of the plurality of products;
controlling the display screen to change a display characteristic of a UI element of the at least one product of the plurality of products based on the received recall information; and
controlling one or more requests associated with the at least one product of the plurality of products based on the received recall information, wherein the one or more requests comprise at least one of: a rent request, an exchange request, or a sale request for the at least one product of the plurality of products.

19. The method according to claim 18, wherein the control of the one or more requests comprises restriction of the one or more requests associated with the at least one product of the plurality of products.

20. A non-transitory computer-readable medium having stored thereon, computer-executable instructions that when executed by a first computing device, causes the first computing device to execute operations, the operations comprising:
controlling a display screen of the first computing device to display a user Interface (UI), wherein the UI displays a plurality of UI elements for a plurality of products purchased by a first user of the first computing device;
transmitting product information associated with at least one product of the plurality of products to a server;
receiving, from the server, recall information associated with the at least one product of the plurality of products, wherein the recall information indicates a recall initiated by a manufacturer or a dealer for the at least one product of the plurality of products;
controlling the display screen to change a display characteristic of a UI element of the at least one product of the plurality of products based on the received recall information; and
controlling one or more requests associated with the at least one product of the plurality of products based on the received recall information, wherein the one or more requests comprise at least one of: a rent request, an exchange request, or a sale request for the at least one product of the plurality of products.
